(19) United States
(12) Patent Application Publication
(10) Pub. No.: US 2026/0228554 A1
(43) Pub. Date: Aug. 6, 2026

(54) DATA MODELING USING ELASTIC WEIGHT CONSOLIDATION PHYSICS-INFORMED NEURAL NETWORKS

(71) Applicant: INTERNATIONAL BUSINESS MACHINES CORPORATION, ARMONK, NY (US)

(72) Inventors: Srinath Madasu, Houston, TX (US); SEAN WAGNER, Mississauga (CA)

(21) Appl. No.: 19/042,041

(22) Filed: Jan. 31, 2025

(51) Int. Cl. G06N 3/096; G06N 3/084

(52) U.S. Cl. CPC G06N 3/096; G06N 3/084

(57) ABSTRACT

According to one embodiment, a method, computer system, and computer program product for implementing a deep physics neural network for modeling data using a hybrid training approach is provided. The present invention may include training a physics-informed neural network (PINN) by incorporating a mathematical equation model, and its boundary and initial conditions, into the PINN; pre-training an elastic weight consolidation physics-informed neural network (EWC-PINN) using a transfer learning method; and training the EWC-PINN using noisy training data.

### BACKGROUND

The present invention relates, generally, to the field of computing, and, more particularly to physics-informed neural networks (PINNs) and deep physics neural networks (DPNNs).

PINNs are a type of neural network that encode model equations, such as Partial Differential Equations (PDE), as a component of the neural network itself by constraining the network to follow the known physical laws during training. DPNNs are a type of neural network that incorporate some physics constraints into its architecture, comprising layers of physical systems, during training. Thereby, PINNs are suited for solving complex physics problems, while DPNNs are suited toward solving a wide range of problems in which at least some physics understanding is beneficial.

### SUMMARY

Embodiments of a method, a computer system, and a computer program product for implementing a deep physics neural network for modeling data using a hybrid training approach are described. According to one embodiment, a method, computer system, and computer program product for implementing a deep physics neural network for modeling data using a hybrid training approach may include training a physics-informed neural network (PINN) by incorporating a mathematical equation model, and its boundary and initial conditions, into the PINN; pre-training an elastic weight consolidation physics-informed neural network (EWC-PINN) using a transfer learning method; and training the EWC-PINN using noisy training data.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 is an operational flowchart illustrating an elastic weight consolidation physics-informed neural network training process according to at least one embodiment.

FIG. 3 is an illustration of an elastic weight consolidation physics-informed neural network implementation process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

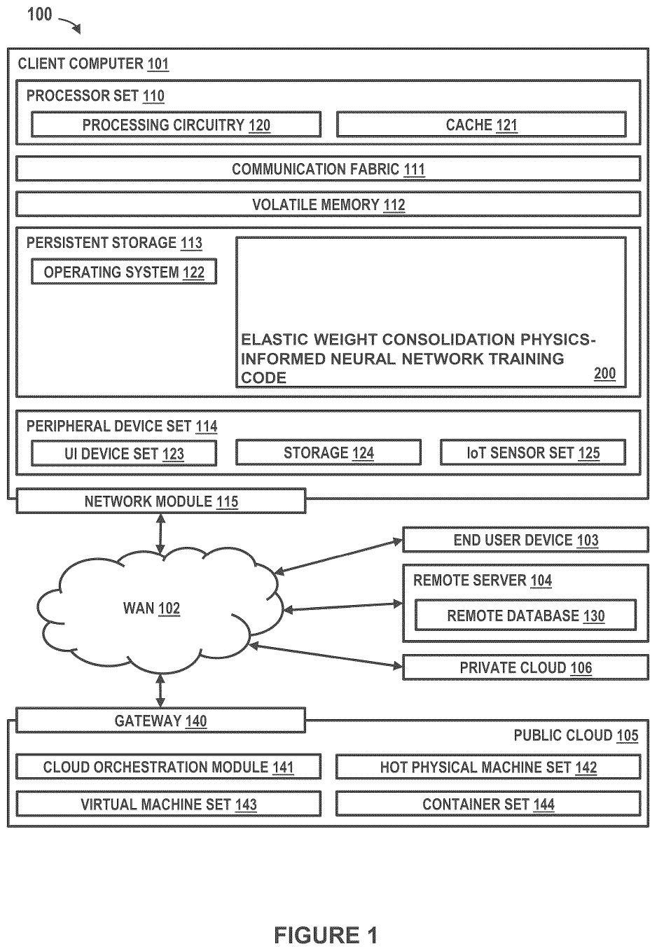

Embodiments of the present invention relate generally to the field of computing, and, in particular to physics-informed neural networks (PINNs). The present embodiment has the capacity to improve the training and, as a result, the implementation of physics-informed neural networks by eliminating the phenomenon known as catastrophic forgetting, i.e. the tendency of machine learning models to “forget” (lose) the knowledge of previously learned information as more tasks are learned by the models. The present embodiment can generate a trained elastic weight consolidation physics-informed neural network (EWC-PINN) for modeling data using a hybrid training approach centered around computing a loss function during the training of a PINN, pre-training the EWC-PINN by transferring the computed layer weights from the trained PINN to the EWC-PINN, and training the EWC-PINN with noisy training data to compute an updated loss function based on the computed layer weights from the trained PINN and the noisy training data. The embodiments mentioned below are further illustrated and described below in the discussions of FIGS. 1, 2, and 3.

Currently, methods that address and eliminate the catastrophic learning phenomenon during training of physics-informed neural networks and deep physics neural networks do not exist. It is important that a method exists that enables physics-based neural networks to remember all acquired knowledge, i.e. learned from the physics and the data, and as a result, maximize the performance of the trained neural networks across all learned tasks. Therefore, an implementation of an elastic weight consolidation physics-informed neural network training process is needed, in which the computed layer weights from the trained PINN are transferred to a deep physics neural network, and used in in conjunction with training data to implement a trained EWC-PINN that retains all knowledge learned from the related physics and the training data.

According to an aspect of the invention, there is provided an elastic weight consolidation physics-informed neural network training method to train a physics-informed neural network (PINN) by incorporating a mathematical equation model, and its boundary and initial conditions, into the PINN, pre-train an elastic weight consolidation physics-informed neural network (EWC-PINN) using a transfer learning method, and train the EWC-PINN using noisy training data. In this embodiment, the present invention has the advantage of eliminating the catastrophic forgetting phenomenon experienced during the continued training of a physics-informed neural network. The present invention can incorporate any partial differential equation model, and its boundary and initial conditions, into a physics-informed neural network to ensure that the trained physics-informed neural network is governed by the known physics laws corresponding to the partial different equation, thereby providing an efficient and flexible framework for solving a wide range of physics problems. Also, the present invention can train a deep physics neural network using the computed layer weights from the trained PINN as well as noisy training data, thereby ensuring the implementation of a trained deep physics neural network that overcomes the limitations of deep physics neural networks by improving the accuracy and speed of a trained deep physics neural network. The present invention does not require that all advantages need to be incorporated into every embodiment of the invention.

In embodiments, the method comprises receiving noisy input data and processing the noisy input data through the trained EWC-PINN to model the noisy input data. In this embodiment, the present invention has the advantage of implementing the trained EWC-PINN to perform data modeling.

In embodiments, training the PINN further comprises computing a loss function and propagating the loss function into a plurality of classical hidden layers within the PINN using a backpropagation mechanism. In this embodiment, the present invention has the advantage of ensuring that the trained PINN is governed by the known physics laws corresponding to the incorporated mathematical equation model.

In embodiments, the transfer learning method comprises extracting learned weights from a plurality of layers within the PINN and incorporating the learned weights into a plurality of layers within the EWC-PINN. In this embodiment, the present invention has the advantage of integrating the learned physics knowledge from the PINN into the EWC-PINN.

In embodiments, training the EWC-PINN further comprises computing an updated loss function, wherein the updated loss function comprises a penalty term, using the noisy training data and the learned weights from the plurality of layers within the PINN, and propagating the updated loss function into a plurality of classical hidden layers within the EWC-PINN using a backpropagation mechanism. In this embodiment, the present invention has the advantage of ensuring that the trained EWC-PINN is governed by the known physics laws corresponding to the incorporated mathematical equation model, as well as minimizing the error margin of the EWC-PINN's output. Additionally, in this embodiment, the present invention has the advantage of constraining the modification of the important weights of the EWC-PINN during training, thus balancing the learning of the noisy training data while preserving the learned physics knowledge from the PINN.

In embodiments, the PINN and the EWC-PINN are implemented in a quantum computing environment. In this embodiment, the present invention has the advantage of improving the performance metrics, for example, but not limited to, the accuracy and speed, of the PINN and the EWC-PINN.

In embodiments, the trained EWC-PINN retains acquired knowledge learned throughout continued training of the EWC-PINN. In this embodiment, the present invention has the advantage of eliminating the phenomenon known as catastrophic forgetting during training of the EWC-PINN.

In at least one exemplary embodiment, the program trains an EWC-PINN and implements the trained EWC-PINN for fluid mechanics data modeling applications, such as computing fluid velocities over a range of time by applying Burgers' Equation, a partial differential equation (PDE) used for modeling fluid dynamics and other physical processes. The program feeds a PDE model representing Burgers' Equation and the corresponding data set of collocation points into the PINN to incorporate the PDE model into the PINN and compute the physics formulation loss function, i.e. train the PINN. Once the PINN is trained, the program can perform transfer learning by freezing the weights of the PINN's layers and transferring the weights to a deep physics neural network, i.e. the EWC-PINN, to pre-train the deep physics neural network. Once the deep physics neural network is pre-trained, the program can retrieve noisy training data, whereby the noisy training data comprises labeled data sets of fluid velocities and time and labeled modeled data based on the corresponding labeled data sets of fluid velocities and time. The program can feed the noisy training data into the deep physics neural network to train the deep physics neural network to model the behavior of fluid velocities, and compute the EWC-PINN loss function, thus building an EWC-PINN. Once the trained EWC-PINN is built, the program can retrieve noisy input data from the database, whereby the noisy input data was gathered from one or more fluid sensors, and whereby the noisy input data comprises measured data sets of fluid velocities. The program can feed the noisy input data into the trained EWC-PINN. The trained EWC-PINN can process the noisy input data and can output a representation of the modeled noisy input data, for example, a line plot of fluid velocity vs. time based on the processed noisy input data.

In at least one exemplary embodiment, the program trains an EWC-PINN and implements the trained EWC-PINN for fluid mechanics data modeling applications, such as computing the permeability of fluid in an oil reservoir by applying Darcy's Law, a linear flow model for water flow through a saturated porous medium. The program feeds a PDE model representing Darcy's Law and the corresponding data set of collocation points into the PINN to incorporate the PDE model into the PINN and compute the physics formulation loss function, i.e. train the PINN. Once the PINN is trained, the program can perform transfer learning by freezing the weights of the PINN's layers and transferring the weights to a deep physics neural network, i.e. the EWC-PINN, to pre-train the deep physics neural network. Once the deep physics neural network is pre-trained, the program can retrieve noisy training data, whereby the noisy training data comprises labeled data sets of fluid permeability, saturation, and labeled modeled data based on the corresponding labeled data sets of fluid permeability and saturation. The program can feed the noisy training data into the deep physics neural network to train the deep physics neural network to model the behavior of a viscous fluid, and compute the EWC-PINN loss function, thus building an EWC-PINN. Once the trained EWC-PINN is built, the program can retrieve noisy input data from the database, whereby the noisy input data was gathered from one or more fluid sensors, and whereby the noisy input data comprises measured data sets of fluid permeability and saturation. The program can feed the noisy input data into the trained EWC-PINN. The trained EWC-PINN can process the noisy input data and can output a representation of the modeled noisy input data, for example, a line plot of the relative permeability of porous fluid vs. change in saturation based on the processed noisy input data.

In at least one exemplary embodiment, the program trains an EWC-PINN and implements the trained EWC-PINN for financial sector data modeling applications, such as computing estimated option prices over a range of time by applying Black-Scholes' Law, a mathematical model for the dynamics of a financial market containing derivative investment instruments. The program feeds a PDE model representing Black-Scholes' Law and the corresponding data set of collocation points into the PINN to incorporate the PDE model into the PINN and compute the physics formulation loss function, i.e. train the PINN. Once the PINN is trained, the program can perform transfer learning by freezing the weights of the PINN's layers and transferring the weights to a deep physics neural network, i.e. the EWC-PINN, to pre-train the deep physics neural network. Once the deep physics neural network is pre-trained, the program can retrieve noisy training data, whereby the noisy training data comprises labeled data sets of assets, prices, time, and labeled modeled data based on the corresponding labeled data sets of assets, prices, and time. The program can feed the noisy training data into the deep physics neural network to train the deep physics neural network to model the behavior of asset prices, and compute the EWC-PINN loss function, thus building an EWC-PINN. Once the trained EWC-PINN is built, the program can retrieve noisy input data from the database, whereby the noisy input data was gathered from one or more stock market resources, and whereby the noisy input data comprises measured data sets of asset prices. The program can feed the noisy input data into the trained EWC-PINN. The trained EWC-PINN can process the noisy input data and can output a representation of the modeled noisy input data, for example, a line plot of asset prices vs. time based on the processed noisy input data.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to train a physics-informed neural network (PINN) by incorporating a mathematical equation model, and its boundary and initial conditions, into the PINN, pre-train an elastic weight consolidation physics-informed neural network (EWC-PINN) using a transfer learning method, and train the EWC-PINN using noisy training data.

Referring to FIG. 1, an exemplary networked computer environment 100 is depicted, according to at least one embodiment. Computing environment 100 contains an example of an environment for the execution of at least some of the computer code involved in performing the inventive methods, such as elastic weight consolidation physics-informed neural network training code 200, also referred to as “elastic weight consolidation physics-informed neural network training program 200”, or “the program 200”. In addition to code block 200 computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. Additionally, peripheral device set 114 may comprise sensors, such as fluid sensors, field sensors, etc. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The database 130 may be a digital repository capable of data storage and data retrieval. The database 130 can be present in the remote server 104 and/or any other location in the network 102. The database 130 may comprise a knowledge corpus, whereby the knowledge corpus is maintained by the program 200. The knowledge corpus can store collected organized noisy training data, i.e. data modeling training data comprising noise. The noisy training data can comprise previously uploaded labeled data sets, such as data sets with measurements of fluid velocity, fluid temperature, fluid viscosity, fluid pressure, asset prices, drift rate of asset prices, standard deviation of asset returns, etc. Additionally, the noisy training data can comprise labeled modeled data based on corresponding labeled data sets, such as simulation results of stock prices over a range of years and fluid velocities over a time period. Also, the knowledge corpus can comprise mathematical equation models and corresponding data sets of collocation points, such as partial differential equation (PDE) models and data sets of collocation points for the corresponding PDEs. A mathematical equation model can comprise any mathematical formula that is used to model a phenomena or data trend, either physics-related or non-physics related. In at least one embodiment, the mathematical equation model may comprise a PDE. Also, the knowledge corpus can comprise uploaded noisy input data, i.e. data modeling input data comprising noise, received through sensors 114 or through accessing one or more publicly available resources, such as, but not limited to, financial data sources, and crawled data from the internet. The database 130 can store the trained physics-informed neural network (PINN) and the trained elastic weight consolidation physics-informed neural network (EWC-PINN). The database 130 can store outputted parameters/weights from the trained PINN and outputted modeling data from the trained EWC-PINN.

The PINN can comprise an input layer, a plurality of classical hidden layers, and an output layer. Additionally, the PINN may comprise one or more skip connections between its layers. The PINN may use skip connections to directly feed the output of one layer as input into another layer.

The EWC-PINN can be a deep physics neural network. The EWC-PINN can comprise an input layer, a plurality of classical hidden layers, and an output layer. Additionally, the EWC-PINN may comprise one or more skip connections between its layers. The EWC-PINN may use skip connections to directly feed the output of one layer as input into another layer.

In at least one embodiment, the PINN and the EWC-PINN may be implemented in a quantum computing environment. In such an embodiment, the PINN and the EWC-PINN may additionally comprise a quantum neural network (QNN). The QNN may comprise one or more layers, each formed using a data encoding circuit and a parameterized circuit. The data encoding circuit, also referred to as feature mapping layers, can encode the input data directly or the output data from the plurality of classical hidden layers, i.e. classical data, into the collective state of a set of qubits using a number of methods, such as by encoding output data into rotation angles of arbitrary rotation gates acting on qubits, for example, by using a series of R_{Z} (or Phase) and R_{ZZ} gates. In at least one embodiment, a ZZ feature map may be used to encode classical data using a series of one- and two-qubit rotation gates, and may be implemented using the circuit library in the Qiskit™ (Qiskit™ and all Qiskit™-based trademarks and logos are trademarks or registered trademarks of IBM Corporation, and/or its affiliates) open source software project. The parameterized circuit, also referred to as parameterized layers, may comprise quantum gates, for example CNOT gates, with tunable parameters, for example a set of R_{Y} gates, that are adjusted via the training process. The data encoding circuit and the parameterized circuit may take different forms in terms of the composition of the quantum circuits used.

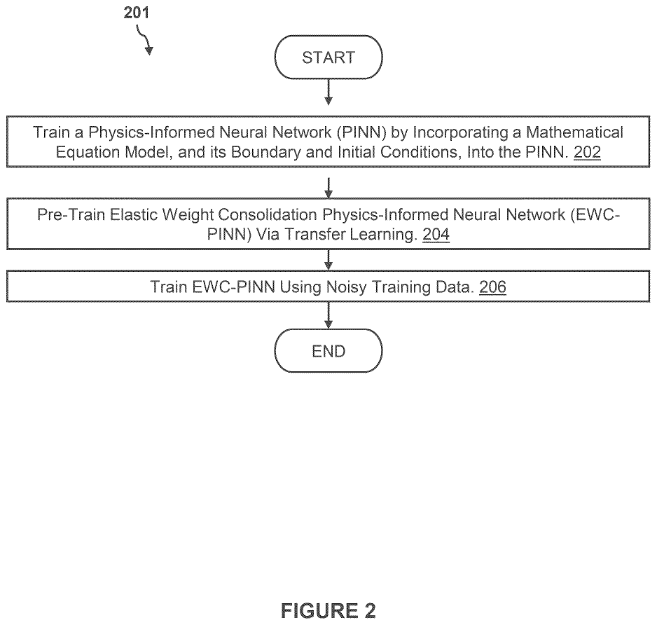

According to the present embodiment, the elastic weight consolidation physics-informed neural network training program 200 may be a program capable of training a physics-informed neural network (PINN) by incorporating a mathematical equation model, and its boundary and initial conditions, into the PINN. Also, the program 200 may be a program capable of pre-training an elastic weight consolidation physics-informed neural network (EWC-PINN) using a transfer learning method. Additionally, the program 200 may be a program capable of training the EWC-PINN using noisy training data. Furthermore, the program 200 may be a program capable of receiving noisy input data and processing the noisy input data through the trained EWC-PINN to perform data modeling of the noisy input data. The program 200 may be located on client computing device 101 or remote server 104 or on any other device located within network 102. Furthermore, the program 200 may be distributed in its operation over multiple devices, such as client computing device 101 and remote server 104. The elastic weight consolidation physics-informed neural network training method is explained in further detail below with respect to FIG. 2.

Referring now to FIG. 2, an operational flowchart illustrating an elastic weight consolidation physics-informed neural network training process 201 is depicted according to at least one embodiment. At 202, the program 200 trains a physics-informed neural network (PINN) by incorporating a mathematical equation model, and its boundary and initial conditions, into the PINN. The program 200 can access and retrieve mathematical equation models and their corresponding data sets of collocation points from the knowledge corpus within the database 130. The program 200 can input a retrieved mathematical equation model and its corresponding data set of collocation points into the input layer of the PINN. The PINN can feed the mathematical equation model and the corresponding data set of collocation points through the PINN's plurality of classical hidden layers to learn the domain knowledge, for example, physics knowledge, of the mathematical equation model, such as a partial differential equation (PDE) model, i.e. the constraints of the mathematical equation model. As the mathematical equation model and the corresponding data set of collocation points are fed through the PINN, the PINN can learn to enforce the initial and boundary conditions of the mathematical equation model on the PINN, as well as fulfill the mathematical equation model, using the corresponding data set of collocation points. The program 200 can train the PINN for an application in any technical discipline, such as financial mathematics, heat transfer, structural dynamics, fluid mechanics, solid mechanics, etc., that involves modeling measured data, in which at least some of the measured data is noisy. The program 200 can incorporate the mathematical equation model corresponding to the specific application that the PINN is being trained for, for example, Black-Scholes in financial mathematics and Darcy's law in reservoir simulations, into the PINN. In at least one embodiment, for example, the PINN can be trained for fluid mechanics applications by incorporating the Burgers' Equation, a PDE used to model fluid dynamics and other physical processes, represented below:

$$\frac{{\partial }_{u}}{{\partial }_{t}} - v \frac{( {\partial }^{2} u )}{\partial {x}^{2}} + \frac{{\partial }_{u}}{{\partial }_{x}} = 0$$

The PINN can represent the velocity as u, where u=(x,t). The PINN can represent the viscosity as v. The PINN can represent the spatial location as x. The PINN can represent the time as t. The program 200 can input a data set of collocation points, u(0,t)=0, u(1,t)=0, and u(x,0)=sin(πx), to enforce the initial and boundary conditions of the Burgers' Equation on the PINN, as well as fulfill the Burgers' Equation, as represented below (with added noise):

$$u ( x , t ) = \frac{2 πv {\sum }_{n = 1}^{∞} {a}_{n} exp ( - {n}^{2} {π}^{2} vt ) n sin ( n π x )}{{a}_{0} + {\sum }_{n = 1}^{∞} {a}_{n} exp ( - {n}^{2} {π}^{2} vt ) n cos ( n π x )} + noise factor \times random distrobution$$

Additionally, the program 200 can further train the PINN by introducing a physics formulation loss function, such as mean square error or cross-entropy, to optimize the weights, also known as parameters, of the PINN. The program 200 can compute the physics formulation loss function using the PDE model, as well as the constraints of the PDE within the following formula:

$${ℒ}_{Physics Formulation} = mean ( abs \frac{{\partial }_{u}}{{\partial }_{t}} - v \frac{( {\partial }^{2} u )}{\partial {x}^{2}} + \frac{{\partial }_{u}}{{\partial }_{x}} ) + abs ( u ( x , 0 ) - sin ( π x ) ) + abs ( u ( 0 , t ) ) + abs ( u ( 1 , t ) )$$

The PINN can represent the physics formulation loss function as [symbol] . The program 200 can train the PINN with the computed physics formulation loss function, [symbol] , using a backpropagation mechanism to propagate the loss function into the PINN's plurality of classical hidden layers.

In embodiments where the PINN is implemented in a quantum computing environment, the physics formulation loss function, [symbol] , may be represented as:

$${ℒ}_{Physics Formulation} = {ℒ}_{n n} ( x , t ; θ ) + {ℒ}_{r} ( x , t ; θ )$$

The PINN can represent the parameters of the QNN as θ. The PINN can represent the loss associated with the PINN and the input data as [symbol] . The PINN can represent the residual loss from the domain mathematical model as [symbol] . For example, the residual loss [symbol] associated with an implementation of the Burgers equation may be represented as:

$${ℒ}_{r} ( x , t ; θ ) = mean ( {( \frac{\partial {u}_{n n} ( x , t ; θ )}{{\partial }_{t}} - v \frac{{\partial }^{2} {u}_{n n} ( x , t ; θ )}{\partial {x}^{2}} + \frac{( {\partial }^{2} {u}_{n n} ( x , t ; θ )}{{\partial }_{x}} )}^{2} ) ;$$

whereby uₙₙ is computed as the PINN is trained.

At 204, the program 200 pre-trains an elastic weight consolidation physics-informed neural network (EWC-PINN) via transfer learning. The program 200 can perform transfer learning by freezing the weights of the PINN's layers and subsequently, transferring the weights to a new deep physics neural network, i.e. the EWC-PINN. By transferring the weights of the PINN's layers to the EWC-PINN, the program 200 can incorporate the computed physics formulation loss function, [symbol] , into the EWC-PINN. As a result, the EWC-PINN can learn the domain knowledge of the mathematical equation model, for example, the constraints of a PDE model, and thus, integrate the learned physics knowledge during data modeling processing implementations of the EWC-PINN.

At 206, the program 200 trains the EWC-PINN using noisy training data. The program 200 can access and retrieve the noisy training data from the knowledge corpus within database 130. The program 200 can input the noisy training data into the EWC-PINN into the input layer of the EWC-PINN. The EWC-PINN can feed the noisy training data through its plurality of classical hidden layers to learn to model noisy input data for specific data modeling applications related to the mathematical equation model that was integrated into the PINN, for example, a fluid dynamics-based application whereby the Burgers' Equation was integrated into the PINN. As the noisy training data is fed through the EWC-PINN, the EWC-PINN can learn to model noisy data based on analyzing the noisy input data with respect to the constraints of the corresponding integrated mathematical equation model. For example, in a fluid dynamics-based data modeling application, the program 200 may train the EWC-PINN using noisy training data to learn to model the behavior of a viscous fluid based on inputted fluid data from sensors 114 and the constraints of the PDE model, the Burgers' Equation, represented within the computed physics formulation loss function, [symbol] .

Additionally, the program 200 trains the EWC-PINN by introducing an EWC-PINN loss function, [symbol] , also known as the updated loss function, such as mean square error or cross-entropy, to optimize the weights of the EWC-PINN, as well as incorporating the computed physics formulation loss function, [symbol] , learned via the integration of the learned weights from the plurality of layers within the trained PINN, into the EWC-PINN's loss function. The program 200 can compute the EWC-PINN loss function using the noisy training data and the computed physics formulation loss function, [symbol] , within the following formula:

$${ℒ}_{EWC - PINN} = mean ( {( {u}_{Predicted value} - {u}_{Data value} )}^{2} + {λ ( {Weight}_{Physics} - {Weight}_{Data} )}^{2}$$

The EWC-PINN can represent the EWC-PINN loss function as [symbol] . The EWC-PINN can represent the scalar, which is used to control the emphasis on the integration of the domain knowledge, i.e. computed physics formulation loss function, as λ. The EWC-PINN can represent the outputted modeling data from the EWC-PINN during the training process as u_{Predicted value}. The EWC-PINN can represent the labeled noisy training data as u_{Data value}. The EWC-PINN can represent weight vectors defining the computed physics formulation loss function, [symbol] , as Weight_{Physics}. The EWC-PINN can represent weight vectors defining the EWC-PINN loss function, [symbol] , excluding the incorporation of the computed physics formulation loss function, as Weight_{Data}. Computing an updated loss function using the computed physics formulation loss function enables the EWC-PINN to comprise a loss function with a penalty term, for example, a quadratic penalty. The penalty term constrains the modification of important weights within the layers of the EWC-PINN and preserves the knowledge comprised within the computed physics formulation loss function, [symbol] . The program 200 can train the EWC-PINN with the computed EWC-PINN loss function, [symbol] , using a backpropagation mechanism to propagate the loss function into the EWC-PINN's plurality of classical hidden layers. By training the EWC-PINN using the noisy training data, as well as integrating the computed physics formulation loss function, [symbol] , from the PINN into the EWC-PINN's loss function, [symbol] , the program 200 can train the EWC-PINN to learn to retain the domain knowledge from previously learned tasks as more data is processed (learned) through the neural network, and therefore, eliminate the phenomenon of catastrophic forgetting. As a result, the EWC-PINN can more accurately and efficiently model noisy data.

In embodiments where the EWC-PINN is implemented in a quantum computing environment, the program 200 can train the QNN within the EWC-PINN in the same manner as above, except that weights of the QNN will be encoded onto qubits using one of several data encoding methods, including, for example, the rotation angles of arbitrary rotation gates acting on qubits. Thus, the penalty term of the loss function involving the weights of the layers in the QNN within the EWC-PINN may be different than the penalty term of the loss function involving the weights of the rest of the layers in the EWC-PINN.

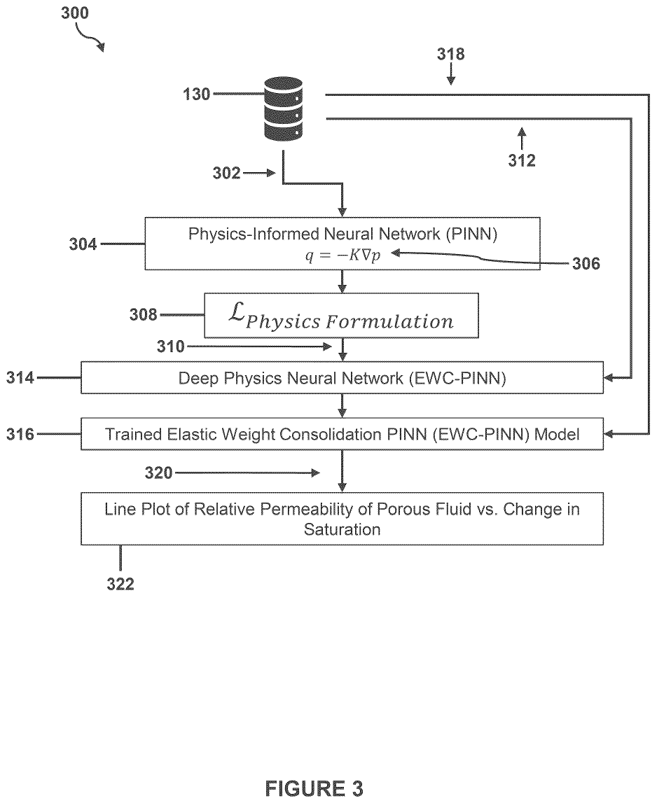

Referring now to FIG. 3, an elastic weight consolidation physics-informed neural network implementation process 300 is depicted according to at least one embodiment. In an exemplary implementation embodiment, the process 300 may comprise training an elastic weight consolidation PINN (EWC-PINN) and implementing the trained EWC-PINN 316 for fluid mechanics data modeling applications, such as computing the permeability of fluid in an oil reservoir by applying Darcy's Law, a linear flow model for water flow through a saturated porous medium. In such an implementation, the program 200 retrieves a partial differential equation (PDE) model representing Darcy's Law 306 and the corresponding data set of collocation points from the database 130. The program 200 feeds 302 the PDE model 306 and the data set of collocation points into the physics-informed neural network (PINN) 304 to incorporate the PDE model 306 into the PINN and compute the physics formulation loss function, [symbol] 308, i.e. train the PINN 304.

Once the PINN 304 is trained, the program 200 can perform transfer learning by freezing the weights of the PINN's 304 layers and transferring 310 the weights to a deep physics neural network 314, i.e. the EWC-PINN, to pre-train the deep physics neural network 314. Once the deep physics neural network 314 is pre-trained, the program 200 can retrieve noisy training data, whereby the noisy training data comprises labeled data sets of fluid permeability, saturation, and labeled modeled data based on the corresponding labeled data sets of fluid permeability and saturation, from the database 130. The program 200 can feed 312 the noisy training data into the deep physics neural network 314 to train the deep physics neural network 314 to model the behavior of a viscous fluid, and compute the EWC-PINN loss function as [symbol] , thus building a trained EWC-PINN model 316.

Once the trained EWC-PINN 316 is built, the program 200 can retrieve noisy input data from the database 130, whereby the noisy input data was gathered from one or more fluid sensors 114, and whereby the noisy input data comprises measured data sets of fluid permeability and saturation. The program 200 can feed 318 the noisy input data into the trained EWC-PINN 316. The trained EWC-PINN 316 can process the noisy input data and can output 320 a representation of the modeled noisy input data, for example, a line plot of relative permeability of porous fluid vs. change in saturation 322 based on the processed noisy input data.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for implementing a deep physics neural network for modeling data using a hybrid training approach, the method comprising:
training a physics-informed neural network (PINN) by incorporating a mathematical equation model, and its boundary and initial conditions, into the PINN;
pre-training an elastic weight consolidation physics-informed neural network (EWC-PINN) using a transfer learning method; and
training the EWC-PINN using noisy training data.

2. The method of claim 1, further comprising:
receiving noisy input data; and
processing the noisy input data through the trained EWC-PINN to model the noisy input data.

3. The method of claim 1, wherein training the PINN further comprises computing a loss function and propagating the loss function into a plurality of classical hidden layers within the PINN using a backpropagation mechanism.

4. The method of claim 1, wherein the transfer learning method comprises extracting learned weights from a plurality of layers within the PINN and incorporating the learned weights into a plurality of layers within the EWC-PINN.

5. The method of claim 4, wherein training the EWC-PINN further comprises computing an updated loss function, wherein the updated loss function comprises a penalty term, using the noisy training data and the learned weights from the plurality of layers within the PINN, and propagating the updated loss function into a plurality of classical hidden layers within the EWC-PINN using a backpropagation mechanism.

6. The method of claim 1, wherein the PINN and the EWC-PINN are implemented in a quantum computing environment.

7. The method of claim 1, wherein the trained EWC-PINN retains acquired knowledge learned throughout continued training of the EWC-PINN.

8. A computer system for implementing a deep physics neural network for modeling data using a hybrid training approach, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
training a physics-informed neural network (PINN) by incorporating a mathematical equation model, and its boundary and initial conditions, into the PINN;
pre-training an elastic weight consolidation physics-informed neural network (EWC-PINN) using a transfer learning method; and
training the EWC-PINN using noisy training data.

9. The computer system of claim 8, further comprising:
receiving noisy input data; and
processing the noisy input data through the trained EWC-PINN to model the noisy input data.

10. The computer system of claim 8, wherein training the PINN further comprises computing a loss function and propagating the loss function into a plurality of classical hidden layers within the PINN using a backpropagation mechanism.

11. The computer system of claim 8, wherein the transfer learning method comprises extracting learned weights from a plurality of layers within the PINN and incorporating the learned weights into a plurality of layers within the EWC-PINN.

12. The computer system of claim 11, wherein training the EWC-PINN further comprises computing an updated loss function, wherein the updated loss function comprises a penalty term, using the noisy training data and the learned weights from the plurality of layers within the PINN, and propagating the updated loss function into a plurality of classical hidden layers within the EWC-PINN using a backpropagation mechanism.

13. The computer system of claim 8, wherein the PINN and the EWC-PINN are implemented in a quantum computing environment.

14. The computer system of claim 8, wherein the trained EWC-PINN retains acquired knowledge learned throughout continued training of the EWC-PINN.

15. A computer program product for implementing a deep physics neural network for modeling data using a hybrid training approach, the computer program product comprising:
one or more computer-readable tangible storage medium and program instructions stored on at least one of the one or more tangible storage medium, the program instructions executable by a processor to cause the processor to perform a method comprising:
training a physics-informed neural network (PINN) by incorporating a mathematical equation model, and its boundary and initial conditions, into the PINN;
pre-training an elastic weight consolidation physics-informed neural network (EWC-PINN) using a transfer learning method; and
training the EWC-PINN using noisy training data.

16. The computer program product of claim 15, further comprising:
receiving noisy input data; and
processing the noisy input data through the trained EWC-PINN to model the noisy input data.

17. The computer program product of claim 15, wherein training the PINN further comprises computing a loss function and propagating the loss function into a plurality of classical hidden layers within the PINN using a backpropagation mechanism.

18. The computer program product of claim 17, wherein the transfer learning method comprises extracting learned weights from a plurality of layers within the PINN and incorporating the learned weights into a plurality of layers within the EWC-PINN.

19. The computer program product of claim 18, wherein training the EWC-PINN further comprises computing an updated loss function, wherein the updated loss function comprises a penalty term, using the noisy training data and the learned weights from the plurality of layers within the PINN, and propagating the updated loss function into a plurality of classical hidden layers within the EWC-PINN using a backpropagation mechanism.

20. The computer program product of claim 15, wherein the PINN and the EWC-PINN are implemented in a quantum computing environment.
